(19) United States
(12) Patent Application Publication
(10) Pub. No.: US 2016/0150582 A1
(43) Pub. Date: May 26, 2016

(54) ELECTRONIC DEVICE FOR ESTABLISHING COMMUNICATION BY ELECTRONIC DEVICE

(71) Applicant: Samsung Electronics Co., Ltd., Gyeonggi-do (KR)

(72) Inventors: Bu-Seop JUNG, Gyeonggi-do (KR); Hyuk KANG, Gyeonggi-do (KR); Min-Ji KIM, Seoul (KR); Dong-II SON, Gyeonggi-do (KR); Woo-Sung CHOI, Gyeonggi-do (KR); Jong-Mu CHOI, Gyeonggi-do (KR); Jong-Ho CHOI, Gyeonggi-do (KR)

(73) Assignee: Samsung Electronics Co., Ltd.

(21) Appl. No.: 14/947,427

(22) Filed: Nov. 20, 2015

(30) Foreign Application Priority Data
Nov. 20, 2014 (KR) 10-2014-0162768

(51) Int. Cl. H04W 76/02; H04W 12/06; H04W 4/00

(52) U.S. Cl. CPC H04W 76/023; H04W 4/008; H04W 4/005; H04W 12/06

(57) ABSTRACT

A method and an electronic device are provided and include at least one communication module configured to receive a signal from at least one other electronic device through a first medium, and a processor configured to analyze the signal received from the at least one other electronic device to generate data related to a second medium, and to transmit the generated data to the at least one other electronic device having generated the signal.

### PRIORITY

This application claims priority under 35 U.S.C. §119(a) to a Korean Patent Application filed in the Korean Intellectual Property Office on Nov. 20, 2014 and assigned Serial No. 10-2014-0162768, the entire disclosure of which is incorporated herein by reference.

### BACKGROUND

1. Field of the Disclosure

The present disclosure generally relates to electronic devices and methods for establishing communication among multiple electronic devices.

2. Description of the Related Art

An electronic device may turn on its communication module to enable a search mode and may search and display at least one electronic device for communication in order to establish short-range communication with a predetermined electronic device. When the user selects the predetermined electronic device from among the electronic devices found during the search mode, the user may establish short-range communication with the predetermined electronic device after entering a security PIN number.

The user's actions described above for performing connection procedures is required whenever establishing short-range communication with other electronic devices.

### SUMMARY

To address at least the issues described above, an electronic device is provided that may establish communication in a simplified manner and a method for establishing such connection by the electronic device, according to embodiments of the present disclosure.

To achieve the above and other aspects of the present disclosure, an electronic device includes at least one or more communication modules configured to receive a signal from at least one or more other electronic devices through a first medium and a processor configured to analyze the signal received from the other electronic devices to generate data related to a second medium and to transmit the generated data to the at least one or more other electronic devices having generated the signal.

According to an aspect of the present disclosure, a method for establishing communication by an electronic device includes receiving a signal from at least one or more other electronic devices via a first medium, analyzing the signal received from the at least one or more other electronic devices to generate data related to a second medium, and transmitting the generated data to the at least one or more other electronic devices having generated the signal.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 illustrates a communication network environment according to an embodiment of the present disclosure;

FIG. 2 is a block diagram illustrating an electronic device according to an embodiment of the present disclosure;

FIG. 3 is a block diagram illustrating a program module according to an embodiment of the present disclosure;

FIG. 4 is a block diagram illustrating an electronic device for establishing communication according to an embodiment of the present disclosure;

FIG. 5 is a block diagram illustrating a sensor module according to an embodiment of the present disclosure;

FIG. 6 is a block diagram illustrating a biometric sensor according to an embodiment of the present disclosure;

FIG. 7 is a flowchart illustrating an operation of generating connection information using signal information by an electronic device according to an embodiment of the present disclosure;

FIG. 8 is a block diagram illustrating identification information used in an information exchange control operation according to an embodiment of the present disclosure;

FIGS. 9A and 9B are block diagrams illustrating an operation of correcting an electronic device group by an electronic device according to an embodiment of the present disclosure;

FIG. 10 is a flow diagram illustrating a call flow method for an electronic device to establish communication with another electronic device according to an embodiment of the present disclosure;

FIGS. 11A and 11B are diagrams illustrating an operation of a method for an electronic device to establish communication with another electronic device according to an embodiment of the present disclosure;

FIG. 12 is a flow diagram illustrating a method for an electronic device to establish communication with a plurality of other electronic devices according to an embodiment of the present disclosure;

FIGS. 13A and 13B are diagrams illustrating an operation for an electronic device to establish communication with a plurality of other electronic devices according to an embodiment of the present disclosure;

FIG. 14 is a flow diagram illustrating a method for an electronic device to establish communication with a plurality of other electronic devices according to an embodiment of the present disclosure; and

FIG. 15 is a diagram illustrating an operation for an electronic device to establish communication with a plurality of other electronic devices according to an embodiment of the present disclosure.

Throughout the drawings, like reference numerals will be understood to refer to like parts, components, and structures.

### DETAILED DESCRIPTION

Hereinafter, embodiments of the present disclosure are described with reference to the accompanying drawings. However, it should be appreciated that the present disclosure is not limited to the embodiments presented herein, and all changes and/or equivalents or replacements thereto also belong to the scope of the present disclosure. The same or similar reference denotations may be used to refer to the same or similar elements throughout the specification and the drawings.

As used herein, the terms “have”, “may have”, “include”, “includes”, or “may include” a feature (e.g., a number, function, operation, or a component such as a part) indicate the existence of the feature and do not exclude the existence of other features.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “first” and “second” may modify various components regardless of importance and do not limit the components. These terms are only used to distinguish one component from another. For example, a first user device and a second user device may indicate different user devices from each other regardless of the order or importance of the devices. For example, a first component may be referred to as a second component, and vice versa without departing from the scope of the present disclosure.

It will be understood that when an element (e.g., a first element) is referred to as being (operatively or communicatively) “coupled with/to,” or “connected with/to” another element (e.g., a second element), it can be coupled or connected with/to the other element directly or via a third element. In contrast, it will be understood that when an element (e.g., a first element) is referred to as being “directly coupled with/to” or “directly connected with/to” another element (e.g., a second element), no other element (e.g., a third element) intervenes between the element and the other element.

As used herein, the terms “configured (or set) to” may be interchangeably used with the terms “suitable for,” “having the capacity to,” “designed to,” “adapted to,” “made to,” or “capable of” depending on circumstances. The term “configured (or set) to” does not necessarily mean “specifically designed in hardware to.” Rather, the term “configured to” may mean that a device can perform an operation together with another device or parts. For example, the term “processor configured (or set) to perform A, B, and C” may mean a general purpose processor (e.g., a CPU or application processor) that may perform the operations by executing one or more software programs stored in a memory device or a dedicated processor (e.g., an embedded processor) for performing the operations.

The terms as used herein are provided merely to describe particular embodiments thereof, but not to limit the scope of other embodiments of the present disclosure. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For example, the electronic device according to embodiments of the present disclosure may include at least one of a smartphone, a tablet personal computer (PC), a mobile phone, a video phone, an e-book reader, a desktop PC, a laptop computer, a netbook computer, a workstation, a PDA (personal digital assistant), a portable multimedia player (PMP), an MP3 player, a mobile medical device, a camera, or a wearable device (e.g., smart glasses, a head-mounted device (HMD), electronic clothes, an electronic bracelet, an electronic necklace, an electronic appcessory, an electronic tattoo, a smart mirror, or a smart watch).

According to an embodiment of the present disclosure, the electronic device may be a smart home appliance. Examples of a smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, examples of the electronic device may include at least one of various medical devices (e.g., diverse portable medical measuring devices, a blood sugar measuring device, a heartbeat measuring device, or a body temperature measuring device), a magnetic resonance angiography (MRA) device, a magnetic resonance imaging (MRI) device, a computed tomography (CT) device, an imaging device, an ultrasonic device, a navigation device, a global positioning system (GPS) receiver, an event data recorder (EDR), a flight data recorder (FDR), an automotive infotainment device, a sailing electronic device (e.g., a sailing navigation device or a gyro compass), avionics, security devices, vehicle head units, industrial or home robots, automatic teller's machines (ATMs), point of sale (POS) devices, or Internet of Things devices (e.g., a light bulb, various sensors, an electric or gas meter, a water sprinkler, a fire alarm, a thermostat, a street light, a toaster, fitness equipment, a hot water tank, a heater, or a boiler).

According to various embodiments of the disclosure, examples of the electronic device may include at least one of a part of furniture, of building/structure, an electronic board, an electronic signature receiving device, a projector, or various measurement devices (e.g., devices for measuring properties of water, electricity, gas, or electromagnetic waves). According to an embodiment of the present disclosure, the electronic device may be one or a combination of the above listed devices. According to an embodiment of the present disclosure, the electronic device may be a flexible electronic device. The electronic device disclosed herein is not limited to the above listed devices, and may include new electronic devices depending on the development of new technologies.

Hereinafter, electronic devices are described with reference to the accompanying drawings according to particular embodiments of the present disclosure. As used herein, the term “user” may denote a human or another device (e.g., an artificial intelligence electronic device) using the electronic device.

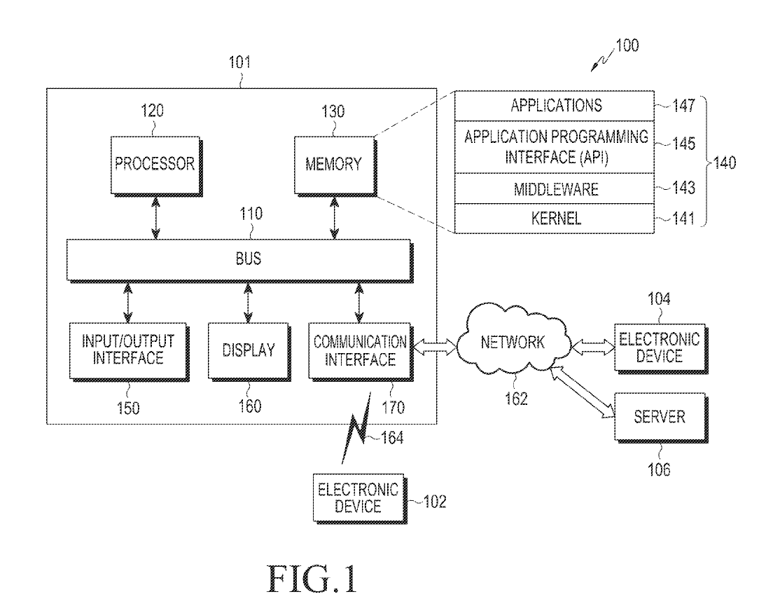

Referring to FIG. 1, according to an embodiment of the present disclosure, an electronic device 101 is included in a network environment 100. The electronic device 101 includes a bus 110, a processor 120, a memory 130, an input/output interface 150, a display 160, and a communication interface 170. In particular embodiments, the electronic device 101 excludes at least one of the components or adds another component.

The bus 110 includes a circuit for connecting the components 110 to 170 with one another and transferring information (e.g., control messages and/or data) between the components.

The processing module 120 includes one or more of a central processing unit (CPU), an application processor (AP), or a communication processor (CP). The processor 120 performs control on at least one of the other components of the electronic device 101, and/or performs an operation or data processing relating to communication.

The memory 130 includes a volatile and/or non-volatile memory. For example, the memory 130 stores commands or data related to at least one other component of the electronic device 101. According to an embodiment of the present disclosure, the memory 130 stores software and/or a program 140. The program 140 includes, e.g., a kernel 141, middleware 143, an application programming interface (API) 145, and/or an application program (or “application”) 147. At least a portion of the kernel 141, middleware 143, or API 145 may be referred to as an operating system (OS).

For example, the kernel 141 controls or manages system resources (e.g., the bus 110, processor 120, or a memory 130) used to perform operations or functions implemented in other programs (e.g., the middleware 143, API 145, or application program 147). The kernel 141 provides an interface that allows the middleware 143, the API 145, or the application 147 to access the individual components of the electronic device 101 to control or manage the system resources.

The middleware 143 functions as an intermediary to allow the API 145 or the application 147 to communicate data with the kernel 141, for example. A plurality of applications 147 may be provided. The middleware 143 controls task requests received from the applications 147, e.g., by determining the priority of using system resources of the electronic device 101 (e.g., the bus 110, the processor 120, or the memory 130) to at least one of the plurality of applications 134.

The API 145 is an interface allowing the application 147 to control functions provided by the kernel 141 or the middleware 143. For example, the API 133 includes at least one interface or function (e.g., a command) for file control, window control, image processing or text control.

The input/output interface 150 serves as an interface that transfers commands or data input from a user or other external devices to other component(s) of the electronic device 101. Further, the input/output interface 150 outputs commands or data received from other component(s) of the electronic device 101 to the user or other external devices.

The display 160 includes, e.g., a liquid crystal display (LCD), a light emitting diode (LED) display, an organic light emitting diode (OLED) display, or a microelectromechanical systems (MEMS) display, or an electronic paper display. The display 160 displays various content (e.g., text, images, videos, icons, or symbols) to the user. The display 160 includes a touchscreen and receives, e.g., a touch, gesture, proximity or hovering input using an electronic pen or a body portion of the user.

The communication interface 170 sets up communication between the electronic device 101 and an external device (e.g., a first electronic device 102, a second electronic device 104, or a server 106). The communication interface 170 may be connected with the network 162 through wireless or wired communication to communicate with the external electronic device.

The wireless communication uses at least one of, e.g., Long Term Evolution (LTE), Long Term Evolution-Advanced (LTE-A), Code Division Multiple Access (CDMA), Wideband Code Division Multiple Access (WCDMA), Universal Mobile Telecommunication System (UMTS), Wireless Broadband (WiBro), or Global System for Mobile communication (GSM) as a cellular communication protocol. The wired connection includes at least one of Universal Serial Bus (USB), High Definition Multimedia Interface (HDMI), recommended standard 232 (RS-232), or plain old telephone service (POTS). The network 162 includes at least one of telecommunication networks, e.g., a computer network (e.g., LAN, WWAN or WAN), Internet, or a telephone network.

The first and second external electronic devices 102 and 104 each may be a device of the same type or different type from the electronic device 101. According to an embodiment of the present disclosure, the server 106 may include a group of one or more servers. According to an embodiment of the present disclosure, all or some of operations executed on the electronic device 101 may be executed on another or multiple other electronic devices 102, 104, or server 106. According to an embodiment of the present disclosure, when the electronic device 101 should perform some function or service automatically or upon request, the electronic device 101, instead of executing the function or service on its own, additionally requests another electronic device 102, 104 or server 106 to perform at least some functions associated therewith. The electronic devices 102 and 104 or server 106 execute the requested functions or additional functions and transfers the result of the execution function to the electronic device 101. The electronic device 101 provides a requested function or service by processing the received result as is or with additional processing. To that end, a cloud computing, distributed computing, or client-server computing technique may be used.

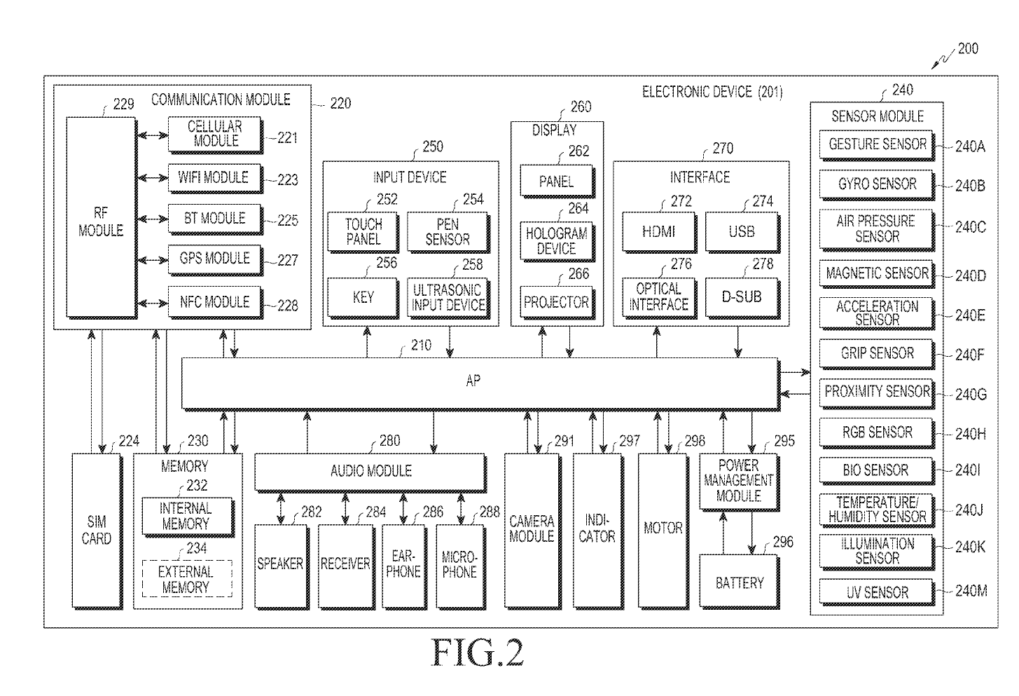

FIG. 2 is a block diagram 200 illustrating an electronic device 201 according to an embodiment of the present disclosure. The electronic device 201 includes the whole or part of the configuration of the electronic device 101 shown in FIG. 1. The electronic device 201 includes one or more application processors (APs) 210, a communication module 220, a SIM (Subscriber Identification Module) card 224, a memory 230, a sensor module 240, an input device 250, a display 260, an interface 270, an audio module 280, a camera module 291, a power management module 295, a battery 296, an indicator 297, and a motor 298.

The AP 210 controls multiple hardware and software components connected to the AP 210 by running, e.g., an operating system or application programs. The AP 210 processes and computes various data. The AP 210 may be implemented in, e.g., a system on chip (SoC). According to an embodiment of the present disclosure, the AP 210 further includes a graphic processing unit (GPU) and/or an image signal processor. The AP 210 includes at least some (e.g., the cellular module 221) of the components shown in FIG. 2. The AP 210 loads a command or data received from at least one of other components (e.g., a non-volatile memory) on a volatile memory, process the command or data, and store various data in the non-volatile memory.

The communication module 220 has the same or similar configuration to the communication interface 160 of FIG. 1. The communication module 220 includes, e.g., a cellular module 221, a wireless fidelity (Wi-Fi) module 223, a Bluetooth (BT) module 225, a global positioning system (GPS) module 227, a near-field communication (NFC) module 228, and a radio frequency (RF) module 229.

The cellular module 221 provides voice call, video call, text, or Internet services through a communication network (e.g., Long Term Evolution (LTE), Long Term Evolution-Advanced (LTE-A), Code Division Multiple Access (CDMA), Wideband Code Division Multiple Access (WCDMA), Universal Mobile Telecommunication System (UMTS), Wireless Broadband (WiBro), or Global System for Mobile communication (GSM). According to an embodiment of the present disclosure, the cellular module 221 performs identification or authentication on the electronic device 201 in the communication network using the SIM card 224 or embedded SIM. According to an embodiment of the present disclosure, the cellular module 221 performs at least some of the functions provided by the AP 210. According to an embodiment of the present disclosure, the cellular module 221 includes a communication processor (CP).

The Wi-Fi module 223, the BT module 225, the GPS module 227, or the NFC module 228 includes a processor for, e.g., processing data communicated through the module. At least some (e.g., two or more) of the cellular module 221, the Wi-Fi module 223, the BT module 225, the GPS module 227, and the NFC module 228 may be included in a single integrated circuit (IC) or an IC package.

The RF module 229 communicates using, e.g., communication signals (e.g., RF signals). The RF module 229 includes, e.g., a transceiver, a power amplifier module (PAM), a frequency filter, a low noise amplifier (LNA), or an antenna. According to an embodiment of the present disclosure, at least one of the cellular module 221, the Wi-Fi module 223, the BT module 225, the GPS module 227, or the NFC module 228 communicates RF signals through a separate RF module.

The SIM card 224 includes a subscriber identification module and/or an embedded SIM, and contains unique identification information (e.g., an integrated circuit card identifier (ICCID) or subscriber information (e.g., an international mobile subscriber identity (IMSI)).

The memory 230 (e.g., the memory 230) includes, e.g., an internal memory 232 or an external memory 234. The internal memory 232 includes at least one of, e.g., a volatile memory (e.g., a dynamic random access memory (DRAM), a static RAM (SRAM), a synchronous dynamic RAM (SDRAM), etc.) or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD).

The external memory 234 includes a flash drive, e.g., a compact flash (CF) memory, a secure digital (SD) memory, a micro-SD memory, a mini-SD memory, an extreme digital (xD) memory, or a Memory Stick™. The external memory 234 may be functionally and/or physically connected with the electronic device 201 via various interfaces.

The sensor module 240 measures a physical quantity or detects an operational state of the electronic device 201, and the sensor module 240 converts the measured or detected physical quantity into an electrical signal. The sensor module 240 includes at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., an Red-Green-Blue (RGB) sensor), a biometric sensor 240I, a temperature/humidity sensor 240J, an illumination sensor 240K, or an ultra violet (UV) sensor 240M. Additionally or alternatively, the sensing module 240 includes, e.g., an E-nose sensor, an electromyography (EMG) sensor, an electroencephalogram (EEG) sensor, an electrocardiogram (ECG) sensor, an infrared (IR) sensor, an iris sensor, or a fingerprint sensor. The sensor module 240 further includes a control circuit for controlling at least one or more of the sensors included in the sensing module. According to an embodiment of the present disclosure, the electronic device 201 further includes a processor configured to control the sensor module 240 as part of an AP 210 or separately from the AP 210, and the electronic device 201 controls the sensor module 240 while the AP is in a sleep mode.

The input unit 250 includes, e.g., a touch panel 252, a (digital) pen sensor 254, a key 256, or an ultrasonic input device 258. The touch panel 252 uses at least one of capacitive, resistive, infrared, or ultrasonic touch sensing methods. The touch panel 252 further includes a control circuit. The touch panel 252 further includes a tactile layer and provides a user with a tactile reaction.

The (digital) pen sensor 254 includes, e.g., a part of a touch panel or a separate sheet for recognition. The key 256 includes e.g., a physical button, optical key or key pad. The ultrasonic input device 258 uses an input tool that generates an ultrasonic signal and enables the electronic device 201 to identify data by sensing the ultrasonic signal to a microphone 288.

The display 260 (e.g., the display 260) includes a panel 262, a hologram device 264, or a projector 266. The panel 262 has the same or similar configuration to the display 160 of FIG. 1. The panel 262 may be implemented to be flexible, transparent, or wearable. The panel 262 may also be incorporated with the touch panel 252 in a module. The hologram device 264 may make three dimensional (3D) images (holograms) in the air by using light interference. The projector 266 displays an image by projecting light onto a screen. The screen may be, for example, located inside or outside of the electronic device 201. In accordance with an embodiment, the display 260 further includes a control circuit to control the panel 262, the hologram device 264, or the projector 266.

The interface 270 includes e.g., a high definition multimedia Interface (HDMI) 272, a USB 274, an optical interface 276, or a D-subminiature (D-sub) 278. The interface 270 may be included in e.g., the communication interface 160 shown in FIG. 1. Additionally or alternatively, the interface 270 includes a mobile high-definition link (MHL) interface, a secure digital (SD) card/multimedia card (MMC) interface, or infrared data association (IrDA) standard interface.

The audio module 280 converts a sound into an electric signal or vice versa. At least a part of the audio module 280 may be included in e.g., the electronic device 101 as shown in FIG. 1. The audio module 280 processes sound information input or output through e.g., a speaker 282, a receiver 284, an earphone 286, or the microphone 288.

The camera module 291 may be a device for capturing still images and videos, and includes, according to an embodiment of the present disclosure, one or more image sensors (e.g., front and back sensors), a lens, an image signal processor (ISP), or a flash such as a light emitting diode (LED) or xenon lamp.

The power manager module 295 manages the power distribution in the electronic device 201. Although not shown, according to an embodiment of the present disclosure, a power management integrated circuit (PMIC), a charger IC, and a battery gauge are included in the power manager module 295. The PMIC may have a wired and/or wireless recharging method. The wireless charging method includes e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge measures the amount of remaining power of the battery 296, a voltage, a current, or a temperature while the battery 296 is being charged. The battery 296 includes, e.g., a rechargeable battery or a solar battery.

The indicator 297 indicates a particular state of the electronic device 201 or a part of the electronic device (e.g., the AP 210), including e.g., a booting state, a message state, or recharging state. The motor 298 converts an electric signal to a mechanical vibration and generates a vibration signal and a vibrational or haptic effect. A vibration signal may also be produced by a MEMS actuator or other electromechanical actuator. Although not shown, a processing unit for supporting mobile TV, such as a GPU may be included in the electronic device 201. The processing unit for supporting mobile TV processes media data conforming to a standard for Digital Multimedia Broadcasting (DMB), Digital Video Broadcasting (DVB), or mediaFLO™.

Each of the aforementioned components of the electronic device includes one or more parts, and the name of the part may vary with the type of the electronic device. The electronic device in accordance with various embodiments of the present disclosure includes at least one of the aforementioned components, omit some of them, or include other additional component(s). Some of the components may be combined into an entity, but the entity performs the same functions as the components may do.

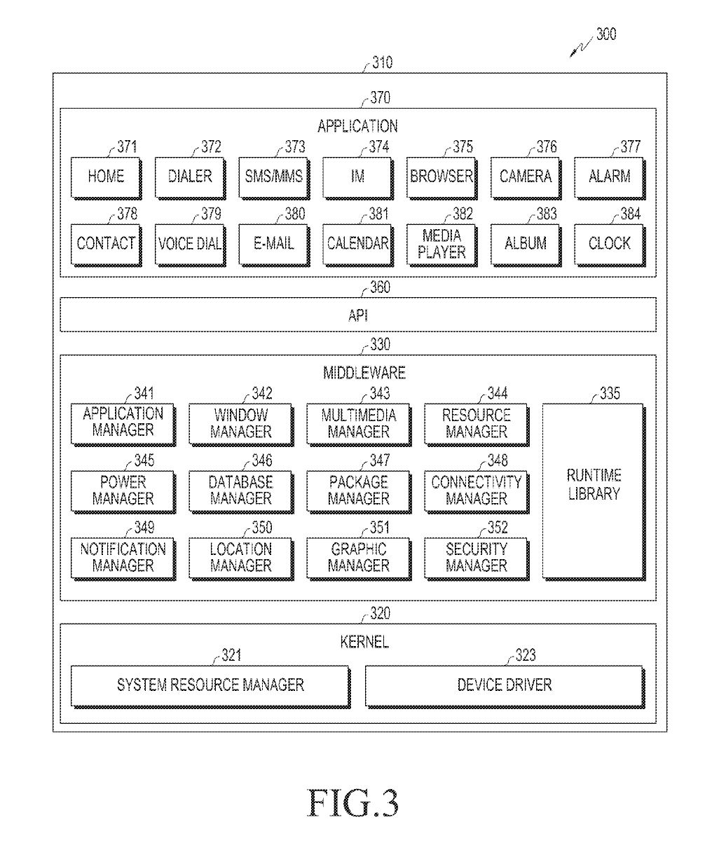

FIG. 3 is a block diagram 300 illustrating a program module 310 according to an embodiment of the present disclosure. According to an embodiment of the present disclosure, the program module 310 (e.g., the program 140) includes an operating system (OS) which controls resources related to the electronic device (e.g., the electronic device 101) and/or various applications (e.g., the application 147). The operating system includes, e.g., Android, iOS, Windows, Symbian, Tizen, or Bada.

The program 310 includes, e.g., a kernel 320, middleware 330, an application programming interface (API) 360, and/or an application 370. At least a part of the program module 310 may be preloaded on the electronic device or may be downloaded from a server (e.g., the server 106).

The kernel 320 (e.g., the kernel 141 of FIG. 1) includes, e.g., a system resource manager 321 or a device driver 323. The system resource manager 321 performs control, allocation, or recovery of system resources. According to an embodiment of the present disclosure, the system resource manager 321 includes a process managing unit, a memory managing unit, or a file system managing unit. The device driver 323 includes, e.g., a display driver, a camera driver, a Bluetooth communication driver, a shared memory driver, a USB driver, a keypad driver, a Wi-Fi driver, an audio driver, or an inter-process communication (IPC) driver.

The middleware 330 provides various functions to the application 370 through the API 360 so that the application 370 efficiently uses the limited system resources in the electronic device or provide functions jointly required by applications 370. According to an embodiment of the present disclosure, the middleware 330 (e.g., middleware 143) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 includes a library module used by a compiler in order to add a new function through a programming language while, e.g., the application 370 is being executed. The runtime library 335 performs input/output management, memory management, or operations of arithmetic functions.

The application manager 341 manages the life cycle of at least one application of, e.g., the applications 370. The window manager 342 manages GUI resources used on the screen. The multimedia manager 343 provides file format management necessary to play various media files and uses media codecs appropriate for particular media content format to perform encoding or decoding on media files. The resource manager 344 manages resources, such as source code of at least one of the applications 370, memory or storage space.

The power manager 345 operates together with, e.g., a basic input/output system (BIOS) to manage battery or power control and provide power information necessary for operating the electronic device. The database manager 346 generates, searches, or modifies a database to be used in at least one of the applications 370. The package manager 347 manages installation or updating of applications that are distributed in the form of a package file.

The connectivity manager 348 manages wireless connectivity such as, e.g., Wi-Fi or Bluetooth. The notification manager 349 displays or notifies an event, such as an incoming message, appointment, or proximity notification, of the user without interfering with the user. The location manager 350 manages location information on the electronic device. The graphic manager 351 manages graphic effects provided to the user and the user related interface. The security manager 352 provides various security functions necessary for system security or user authentication. According to an embodiment of the present disclosure, when the electronic device (e.g., the electronic device 101) has telephony capability, the middleware 330 further includes a telephony manager for managing voice call or video call functions of the electronic device.

The middleware 330 includes a middleware module which forms a combination of various functions of the above-described components. The middleware 330 provides a specific module per type of operating system in order to provide a differentiated function. The middleware 330 dynamically omits some existing components or add new components.

The API 360 (e.g., the API 145) may be a set of API programming functions and may have different configurations depending on the operating system. For example, in the case of Android or iOS, one API set may be provided per platform, and in the case of Tizen, two or more API sets may be offered per platform.

The application 370 includes one or more applications that provides functions such as, e.g., a home 371, a dialer 372, a short message service (SMS)/multimedia messaging service (MMS) 373, an instant message (IM) 374, a browser 375, a camera 376, an alarm 377, a contact 378, a voice dial 379, an email 380, a calendar 381, a media player 382, an album 383, or a clock 384, a health-care monitor (e.g., measuring the degree of workout or blood sugar), or measurement of environmental information (e.g., provision of air pressure, moisture, or temperature information).

According to an embodiment of the present disclosure, the application 370 includes an application (hereinafter referred to as “information exchanging application”) supporting information exchange between the electronic device 101 and an external electronic device 102 or 104. Examples of the information exchange application include, but are not limited to, a notification relay application for transferring specific information to the external electronic device, or a device management application for managing the external electronic device.

The notification relay application includes a function for relaying notification information generated from other applications of the electronic device (e.g., the SMS/MMS application, email application, health-care application, or environmental information application) to the external electronic devices 102 and 104. Further, the notification relay application receives notification information from, e.g., the external electronic device and provides the received notification information to the user. The device management application performs at least some functions of the external electronic device (e.g., the electronic device 104) communicating with the electronic device (for example, turning on/off the external electronic device (or some components of the external electronic device) or control of brightness or resolution of the display), and the device management application manages (e.g., installs, deletes, or updates) an application operating in the external electronic device or a service (e.g., call service or message service) provided by the external electronic device.

According to an embodiment of the present disclosure, the application 370 includes an application (e.g., a health-care application) depending on the attribute (e.g., the type of electronic device such as a mobile medical device) of the external electronic devices 102 and 104. According to an embodiment of the present disclosure, the application 370 includes an application received from the external electronic devices 102 and 104 or the server 106. According to an embodiment of the present disclosure, the application 370 includes a preloaded application or a third party application downloaded from a server 106. The names of the components of the program module 310 according to the present embodiment may vary depending on the type of operating system.

According to an embodiment of the present disclosure, at least a part of the program module 310 may be implemented in software, firmware, hardware, or in a combination of two or more thereof. At least a part of the programming module 310 may be implemented (e.g., executed) by a processor (e.g., the AP 210). At least a part of the program module 310 includes e.g., a module, program, routine, set of instructions, process, or the like for performing one or more functions.

The term ‘module’ refers to a unit including one of hardware, software, and firmware, or a combination thereof. The term ‘module’ may be interchangeably used with a unit, logic, logical block, component, or circuit. The module may be a minimum unit or part of an integrated component. The module may be a minimum unit or part of performing one or more functions. The module may be implemented mechanically or electronically. For example, the module includes at least one of application specific integrated circuit (ASIC) chips, field programmable gate arrays (FPGAs), or programmable logic arrays (PLAs) that perform some operations, which have already been known or will be developed in the future.

According to an embodiment of the present disclosure, at least a part of the device (e.g., modules or their functions) or method (e.g., operations) may be implemented as instructions stored in a computer-readable storage medium e.g., in the form of a program module. The instructions, when executed by a processor (e.g., the processor 120), enable the processor to carry out a corresponding function. The computer-readable storage medium may be e.g., the memory 130.

The computer-readable storage medium includes a hardware device, such as hard discs, floppy discs, and magnetic tapes, optical media such as compact disc read only memories (ROMs), (CD-ROMs) and digital versatile discs (DVDs), magneto-optical media such as floptical disks, ROMs, random access memories (RAMs), flash memories, and the like. Examples of the program instructions include not only machine language code but also high-level language code, which are executable by various computing means using an interpreter. The aforementioned hardware devices may be configured to operate as one or more software modules to carry out embodiments of the present disclosure, and vice versa.

Modules or programming modules in accordance with various embodiments of the present disclosure include at least one or more of the aforementioned components, omit some of them, or further include additional components. Operations performed by modules, programming modules or other components in accordance with various embodiments of the present disclosure may be carried out sequentially, simultaneously, repeatedly, or heuristically. Furthermore, some of the operations may be performed in a different order, or omitted, or include other additional operation(s).

The embodiments disclosed herein are presented for description and understanding of the disclosed technology and does not limit the scope of the present disclosure. Accordingly, the scope of the present disclosure should be interpreted as including all changes or particular embodiments based on the technical spirit of the present disclosure.

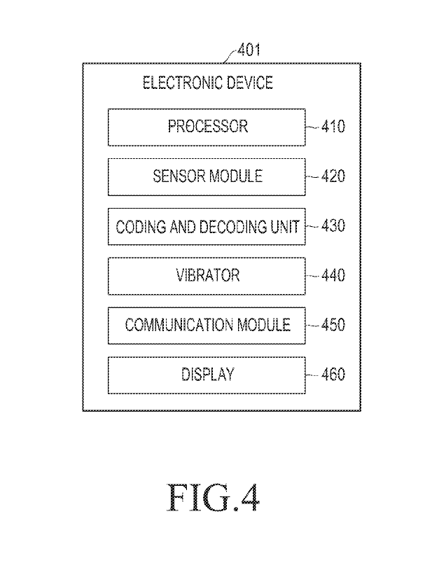

FIG. 4 is a block diagram illustrating an electronic device 401 for establishing communication according to an embodiment of the present disclosure.

Referring to FIG. 4, the electronic device 401 (e.g., the electronic device 101, 102, or 104) includes a processor 410, a sensor module 420, a coding and decoding unit 430, a vibrator 440 for producing a vibration signal, a communication module 450, and a display 460.

According to an embodiment of the present disclosure, the processor 410 may be the processor 120 shown in FIG. 1. The processor 410 may include a hardware module, a software module, a firmware module, or a combination of two or more thereof.

According to an embodiment of the present disclosure, the processor 410 broadcasts a connection information request signal, e.g., a beacon signal, when determining that a connection request trigger occurs. The connection information request signal is not limited to the beacon signal, but includes all periodic signals that are generated based on short-range communication standards. The type of beacon signal available as the connection information request signal includes, e.g., a Bluetooth low energy (BLE) beacon, a Wi-Fi beacon, a neighbor awareness network (NAN) beacon, or a service frame.

According to an embodiment of the present disclosure, the processor 410 determines the occurrence of a first connection request trigger by sensing at least one of a connection request through menu selection, sensing the wearing of an electronic device (e.g., a wearable electronic device) through a sensor, powering on the electronic device, sensing a hardware or software button or a particular gesture, or sensing the running of a service or application. After determining the occurrence of the first connection request trigger, the processor 410 determines whether the electronic device 401 is connected with other electronic devices, such as electronic devices 102 and 104 of FIG. 1. When the electronic device 401 is connected to no other electronic devices, the processor 410 determines the occurrence of a second connection request trigger. The processor 410 upon determining the occurrence of the second connection request trigger, broadcasts the beacon signal through a first medium (e.g., the communication module 450).

According to an embodiment of the present disclosure, the beacon signal includes at least one of basic information on the electronic device, capability information (type of electronic device, type of service, type of sensor, battery level, whether there is a liquid crystal display (LCD) or not, memory size, or random priority value), information on the method for transmitting the connection information (e.g., vibration signal, human body communication, sound, etc.), information on the connection method, or status information on the electronic device (e.g., listening-connection information state, connection information ready state, or connection complete state).

According to an embodiment of the present disclosure, the beacon signal may be broadcast or unicast to a particular electronic device steadily at a predetermined period while the communication module is on. When the beacon signal is broadcast as the connection request trigger occurs, the state information on the electronic device, included in the beacon signal, includes a listening-connection state value indicating the electronic device is waiting receive connection information. When the beacon signal is broadcast after the connection information is received, the state information on the electronic device in the beacon signal includes a connection ready state value indicating the electronic device is waiting for connection. When the beacon signal is broadcast after the connection is complete, the state information on the electronic device in the beacon signal includes a connection-complete value indicating that the connection is completed.

According to an embodiment of the present disclosure, the processor displays, on a user interface (UI), the occurrence of the connection request trigger or at least one electronic device receiving the broadcast beacon signal. For example, when a connection request trigger occurs in a smartwatch and beacon signals are broadcast while the user wears wearable electronic devices, e.g., the smartwatch and smart glasses with the smartphone held on his hand, and the smartphone and smart glasses receive the beacon signals, an arrow directed outwardly may be displayed on the display 460, and arrows directed inwardly may be displayed on the smart glasses and the smartphone.

According to an embodiment of the present disclosure, upon reception of connection information from at least one other electronic device through a second medium (e.g., a material capable of supporting the transmission of a vibration signal including a table, the user's body, external medium, or wireless communication) where the electronic device and the at least one other electronic device are placed, the processor 410 automatically establishes communication with the at least one other electronic device using the received connection information.

According to an embodiment of the present disclosure, the processor 410, after broadcasting the beacon signals, activates at least one sensor module corresponding to the method for transmitting connection information included in the beacon signals to wait to receive connection information. The processor 410, upon reception of connection information from the other electronic device through the activated at least one sensor module, decodes the same using a function (e.g. hash) which was previously retained. For example, when the method for transmitting connection information is a vibration signal, the processor 410 activates the motion sensor to receive the connection information of the vibration signal. When the method for transmitting connection information is human communication, the processor 410 waits to receive connection information through the human body. When the method for transmitting connection information is sound wave signals, the processor 410 activates the microphone.

According to an embodiment of the present disclosure, the processor 410 switches to a search mode to search for and display at least one connectable electronic device and detects the other electronic device having the received connection information from among the at least one electronic device searched. The processor 410 sends a request for pairing to the other electronic device through the first medium using the connection information. When the other electronic device accepts the pairing, the processor 410 automatically establishes communication with the other electronic device or forms a group to establish communication with a plurality of other electronic devices.

According to an embodiment of the present disclosure, upon detection of the other electronic device having the connection information among the at least one electronic device searched in the search mode, the processor 410 checks if the received connection information exactly matches the detected connection information, or when the reliability of the difference between the received connection information and the detected connection information is not less than a threshold, the processor 410 automatically establishes communication with the other electronic device or forms a group to establish communication with a plurality of other electronic devices. When the encoded connection information is decoded using a function (e.g. hash), there may be a gap in the connection information between before coding and after decoding. Thus, an algorithm to determine the level of reliability may be used to determine the reliability of the connection.

According to an embodiment of the present disclosure, automatic establishment of a communication channel or grouping with the other electronic device(s) may be carried out using connection method information included in the beacon signal (e.g., Bluetooth low energy (BLE), Bluetooth (BT), wireless fidelity (Wi-Fi), Wi-Fi direct, independent basic service set (IBSS), ad-hoc, neighbor awareness network (NAN) or mobile hotspot network).

According to an embodiment of the present disclosure, the processor 410 automatically establishes communication with the other electronic device or group of devices using at least one of the connection information or signal strength (e.g., received signal strength indicator (RSSI)). The processor 410 automatically establishes communication or performs grouping on the other electronic devices having a signal strength of a particular level or higher.

According to an embodiment of the present disclosure, when receiving beacon signals broadcast from at least one other electronic device, the processor 410 generates and encodes connection information related to the second medium.

According to an embodiment of the present disclosure, the processor 410 generates or extracts connection information from at least one of a UI of the electronic device, a particular value already stored in the electronic device, a value generated automatically or randomly, a value recognized through sensor information (e.g., when the electronic device is put on the user's body, biometric information is recognized), a particular value received from a designated cloud server, a particular value transmitted from the other electronic device connected with the electronic device, a physical signal created in the electronic device (e.g., a motion signal by the movement of the electronic device), or a physical signal applied from the outside (e.g., a signal generated when hitting the electronic device). The processor 410 encodes the connection information with a function (e.g. hash) previously retained.

According to an embodiment of the present disclosure, the connection information contains an identity (ID) value to automatically identify or group the connected target and a connection key value necessary to establish communication. In the connection information, the identity (ID) value and the connection key value may be differentiated from each other, or the connection information itself may be the ID value or the connection key value.

According to an embodiment of the present disclosure, the designation of an electronic device that generates or transmits the connection information may be made through the capability information (e.g., type or random priority value of the electronic device) of the beacon signal.

According to an embodiment of the present disclosure, the designation of an electronic device that generates or transmits the connection information may be made through negotiation between at least two electronic devices for connection based on the capability information (e.g., type or random priority value of the electronic device) of the beacon signal.

According to an embodiment of the present disclosure, the processor 410 transmits the encoded connection information through the second medium (e.g., a material (e.g., the user's body, external medium, material capable of transmitting a vibration signal, or wireless communication) where the electronic device and the at least one other electronic device are placed) to the other electronic device.

According to an embodiment of the present disclosure, the processor 410 transmits the connection information through the second medium based on the method for transmitting connection information of the beacon signal. For example, when the connection information transmission method is a vibration signal, the processor 410 transmits the connection information to the other electronic device by a vibration signal generated in the vibrator 440 (e.g., a haptic). When the connection information transmission method is human communication, the processor 410 transmits the connection information to the other electronic device by a biometric signal through a human-body communication. “Human-body communication” refers to a technology for transmitting data (e.g., a picture, a video and an MP3) by using a human-body (e.g., arms and legs). The human-body communication technology uses the human body as a medium similar to using a wire, without extra power consumption. That is, it can transmit data (e.g. a picture, a video and a sound source) by shaking hands without a communication network.

When the connection information transmission method is sound waves, the processor 410 transmits the connection information to the other electronic device by a sound generated from the speaker (e.g., a Piezo speaker).

According to an embodiment of the present disclosure, the processor 410 terminates the transmission of the connection information through the second medium after repeating the transmission for a predetermined time period or upon reception of a message for acknowledging the reception of the connection information from the at least one other electronic device.

According to an embodiment of the present disclosure, when forming a group with at least one other electronic device, the processor 410 determines a host electronic device by exchanging capability information before or after forming the group.

According to an embodiment of the present disclosure, the processor 410 exchanges and stores capability information with the at least one other electronic device in search mode before forming the group and determines the host electronic device on its own by applying a predefined priority using the capability information (type or random priority value of the electronic device).

According to an embodiment of the present disclosure, when the electronic device 401 is previously designated as the host electronic device before forming the group, the processor 410 determines the priority of each of the at least one other electronic device to be formed in the group and transmits the information on the priority to the at least one other electronic device.

According to an embodiment of the present disclosure, when the electronic device 401 is previously designated as the host electronic device after forming the group, the processor 410 determines the priority of each of the at least one other electronic device formed in the group and transmits the information on the priority to the at least one other electronic device.

According to an embodiment of the present disclosure, when the group is completely formed, the processor 410 displays the status of the completed group on the UI through the display 460.

According to an embodiment of the present disclosure, when grouping with the at least one other electronic device is complete, the processor 410 displays the connection complete status of the at least one other electronic device within the group on the UI through the display 460.

According to an embodiment of the present disclosure, after grouping with the at least one other electronic device, the processor 410 displays on the UI through the display 460, the other electronic device which has not completed connection among the at least one electronic device selected for grouping in the searching step.

According to an embodiment of the present disclosure, after grouping with the at least one other electronic device is complete and when the electronic device 401 is designated as the host electronic device, the processor 410 periodically correct the group.

According to an embodiment of the present disclosure, when the electronic device 401 is designated as the host electronic device after grouping, the processor 410 determines whether the at least one other electronic device in the group is valid. When the other electronic device is invalid, the processor 410 removes the other electronic device from the group, and when the other electronic device in the group is valid, the processor 410 provides a differentiated communication and service to the other electronic device.

The state of being valid may be determined by at least one of an RSSI measurement or round trip time (RTT) of the electronic device, a sensor measurement pattern, a connection history, a sensor information pattern stored in the host electronic device, or a sensor information pattern received from a cloud server.

For example, when the RSSI or RTT is not greater than a predefined threshold, the other electronic device may be determined to be invalid. When sensor measurement patterns (e.g., motion signals) differ from each other, the other electronic device may be determined to be invalid. When not included in the connection history, the other electronic device may be determined to be invalid. Not having the sensor information pattern (e.g., fingerprint information or iris information) stored in the host electronic device or sensor information pattern received from the cloud server, the other electronic device may be determined to be invalid.

According to an embodiment of the present disclosure, after grouping with the at least one other electronic device is complete and when the electronic device 401 is designated as the host electronic device, the processor 410 controls the at least one other electronic device.

According to an embodiment of the present disclosure, after grouping with the at least one other electronic device is complete and when the electronic device 401 is designated as the host electronic device, the processor 410 designates a sensor measuring role to each of the at least one other electronic device in the group depending on the type of a service or an application performed on the electronic device 401. The processor 410 changes the order or role of sensor measurement of each of the at least one other electronic device and designates at least one of a period of on/off measurement by each sensor, duration, reporting time, reporting method and format or a measurement reporting address. For example, when a smartphone, a smartwatch, and smart glasses are grouped, and a workout-related application is running on the smartphone designated as the host electronic device, the smartphone designates a heart rate pulse measuring role to the smartwatch and receives heart rate pulse information measured by the smartwatch.

According to an embodiment of the present disclosure, after grouping with the at least one other electronic device is complete and when the electronic device 401 is designated as the host electronic device, the processor 410 automatically runs a service as defined in the electronic device 401 depending on the type of the at least one other electronic device in the group. For example, when the at least one other electronic device in the group includes smart glasses, the smartphone designated as the host electronic device automatically runs a video service previously defined on the smart glasses.

According to an embodiment of the present disclosure, after grouping with the at least one other electronic device is complete and when the electronic device 401 is designated as the host electronic device, the processor 410 collects data measured from the at least one other electronic device and stores results obtained by performing analysis and combination on the measured data. The processor 410 transmits the obtained results to an electronic device other than the at least one other electronic device in the group via wired or wireless communication. The processor 410 triggers a particular operation previously defined on the electronic device 401 based on the obtained results. The processor 410 transmits an obtained result to a cloud server and receives a service or application corresponding to the obtained result from the cloud server in a response message. The processor 410 enables the at least one other electronic device to receive the state of the current group by including the obtained result in a beacon signal or search response message and sending the same to the at least one other electronic device in the group.

According to an embodiment of the present disclosure, after grouping with the at least one other electronic device is complete and when the electronic device 401 is designated as the host electronic device, the processor 410 enables any one of the at least one other electronic device to play the role of host through a separate message.

According to an embodiment of the present disclosure, after grouping with the at least one other electronic device is complete and when the electronic device 401 is designated as the host electronic device, if the electronic device 401 leaves the group, the next other electronic device may automatically be designated as the host electronic device depending on the priority.

Conditions resulting in leaving the group include at least one of power-off, user not wearing the electronic device as a result of measuring sensing information, battery time, user's selection, RSSI, or a service or application being executed.

According to an embodiment of the present disclosure, the electronic device having left the group may turn off at least one or more of the sensors which are active.

According to an embodiment of the present disclosure, when all of the electronic devices leave the group after grouping with the at least one other electronic device is complete, it may be displayed on the UI through the display of each electronic device (e.g., the electronic device 401 and at least one other electronic device).

According to an embodiment of the present disclosure, each of the electronic devices grouped (e.g., the electronic device 401) and the at least one other electronic device stores at least one of the connection information or list of electronic devices connected and utilizes the same for subsequent connection.

According to an embodiment of the present disclosure, the sensor module 420 detects signal information for generating connection information and activates the same for reception of connection information after beacon signals are broadcast according to the method for the connection information included in the beacon signals. The sensor module 420 includes at least one sensor. At least one sensor corresponding to the connection information may be activated.

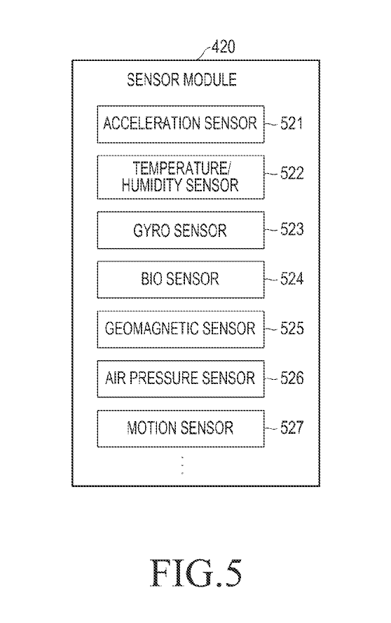

FIG. 5 is a block diagram illustrating a configuration of the sensor module 420 according to an embodiment of the present disclosure. Referring to FIG. 5, the sensor module 420 (e.g., the sensor module 240 of FIG. 2) includes at least one of an acceleration sensor 521, a temperature/humidity sensor 522, a gyro sensor 523, a biometric sensor 524, a geomagnetic sensor 525, an air pressure sensor 526, or a motion sensor 527.

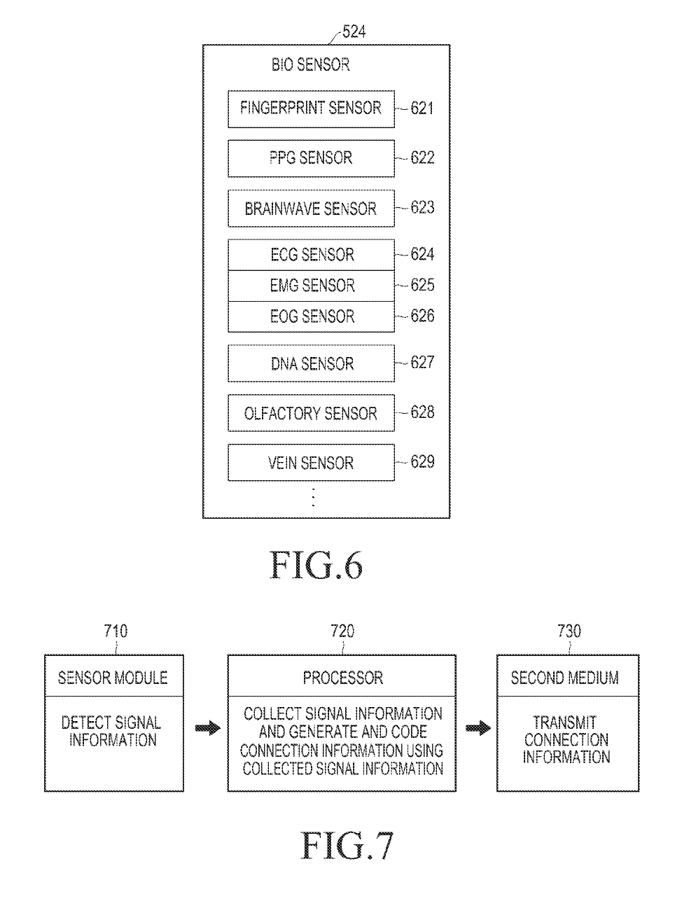

FIG. 6 is a block diagram illustrating a biometric sensor 524 according to an embodiment of the present disclosure. Referring to FIG. 6, the biometric sensor 524 includes at least one of a fingerprint sensor 621, a photoplethysmography (PPG) sensor 622 to measure a pulse, a brainwave sensor 623, an electrocardiography (ECG) sensor 624 to measure an electrocardiogram, an electromyography (EMG) sensor 625 to measure an electromyogram, an electrooculography (EOG) sensor 626 to measure an eyeball or intraocular pressure, a deoxyribonucleic acid (DNA) sensor 627, an olfactory sensor 628, or a vein sensor 629.

According to an embodiment of the present disclosure, the encoding and decoding unit 430 codes the generated connection information through a previously stored function (e.g. hash). The encoding and decoding unit 430 decodes encoded connection information received from another electronic device using the function.

According to an embodiment of the present disclosure, the vibrator 440 generates the connection information as a vibration signal. The vibration signal may be transmitted to at least one other electronic device positioned in or on the second medium (e.g., a desk).

According to an embodiment of the present disclosure, the communication module 450 (e.g., the communication module 220 of FIG. 2) broadcasts beacon signals, multicasts a beacon signal to a group of electronic devices or unicasts a beacon signal to a particular other electronic device in response to the connection request trigger. According to an embodiment of the present disclosure, the communication module 450 may be a first is medium. According to an embodiment of the present disclosure, the communication module 450 broadcasts, multicasts or unicasts beacon signals using BLE communication.

According to an embodiment of the present disclosure, the display 460 (e.g., the display 160 of FIG. 1) displays various information on the UI while the electronic device 401 connects with at least one other electronic device or forms a group with the at least one other electronic device.

According to an embodiment of the present disclosure, the display 460 displays on the UI, the connection request trigger occurring from the electronic device 401 or at least one other electronic device receiving the beacon signals.

According to an embodiment of the present disclosure, when the electronic device 401 completes the connection or grouping with the at least one other electronic device, the display 460 displays the grouping-complete status on the UI.

According to an embodiment of the present disclosure, the communication module 450 may be configured to receive signals from at least one other electronic device through the first medium.

The processor 410 may be configured to determine the signal received from the other electronic device to generate data related to the second medium and to transmit the generated data to the at least one other electronic device having generated the signal.

According to an embodiment of the present disclosure, the data related to the second medium may be transmitted to the other electronic device through the second medium, and the data related to the second medium may be generated based on the signal generated by the at least one other electronic device.

According to an embodiment of the present disclosure, the second medium may be a material on which the at least one other electronic device and the electronic device are placed. The generated data related to the second medium may be transmitted to the at least one other electronic device via the second medium. The at least one other electronic device receives the data related to the second medium and transmits the signal via the first medium.

According to an embodiment of the present disclosure, the second medium may have the electronic device or the at least one other electronic device placed thereon, and the data may be transmitted to the other electronic device via a vibration signal through the second medium.

According to an embodiment of the present disclosure, the data related to the second medium includes information for connection via the first medium. The at least one other electronic device establishes communication with the electronic device through the first medium based on the data received from the electronic device.

According to an embodiment of the present disclosure, the data related to the second medium may be at least one of the user's biometric information items that may be extracted from the second medium where the electronic device is placed, and the processor 410 compares the extracted biometric information with the biometric information included in the data received from the at least one other electronic device.

According to an embodiment of the present disclosure, when the comparison between the extracted biometric information with the biometric information included in the received data shows that the matching degree between the electronic device and the at least one other electronic device exceeds a predefined threshold, the processor 410 may be configured to establish communication via the first medium between the electronic device and the at least one other electronic device. The matching degree may be generated by comparing one or more biometric information factors.

According to an embodiment of the present disclosure, the processor 410 may be configured to send the signal to the at least one other electronic device via the first medium and receive the data related to the second medium from the at least one other electronic device via the second medium.

According to an embodiment of the present disclosure, the processor 410 may be configured to activate at least one or more sensors to receive the data after sending the signal via the first medium.

According to an embodiment of the present disclosure, the processor 410 may be configured to activate the motion sensor when the data is received in a vibration signal via the second medium.

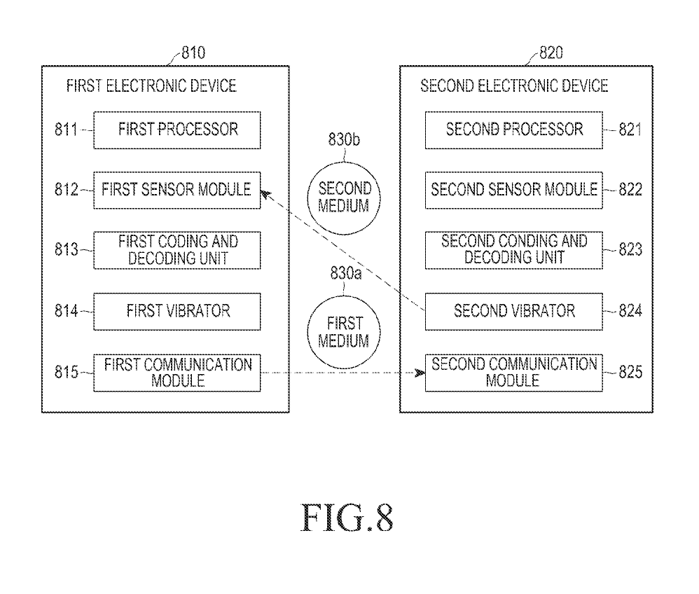

FIG. 7 is a flowchart illustrating an operation of generating connection information using signal information by an electronic device 401 according to an embodiment of the present disclosure. Referring to FIG. 7, at least one sensor of the sensor module 710 (e.g., the sensor module 420) may be activated, and signal information detected by the at least one sensor may be transmitted to the processor 720 (e.g., the processor 410).

The processor 720 collects signal information received from the sensor module 710, generates connection information using the collected signal information, encodes the generated connection information through a previously stored function (e.g. hash), and then sends the same to at least one other electronic device via the second medium 730.

For example, the DNA sensor (e.g., the DNA sensor 627 of FIG. 6) of the biometric sensors may be activated, and DNA signal information detected by the DNA sensor may be transmitted to the processor 720. The processor 720 collects DNA signal information received from the DNA sensor, generates connection information using the collected DNA signal information, encodes the generated connection information through a previously stored function, and then sends the same to at least one other electronic device via the second medium 730.

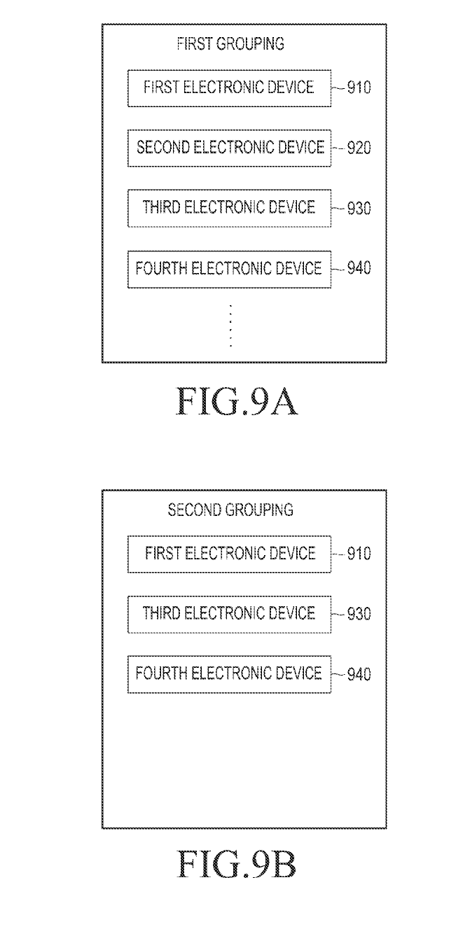

FIG. 8 is a block diagram illustrating identification information used in an information exchange control operation according to an embodiment of the present disclosure. Referring to FIG. 8, the first electronic device 810 includes a first processor 811, a first sensor module 812, a first encoding and decoding unit 813, a first vibrator 814, and a first communication module 815, and the components of the first electronic device 810 includes the processor 410, the sensor module 420, the encoding and decoding unit 430, the vibrator 440, and the communication module 450, respectively, of FIG. 4. Referring to FIG. 8, the second electronic device 820 includes a second processor 821, a second sensor module 822, a second encoding and decoding unit 823, a second vibrator 824, and a second communication module 825, and the components of the second electronic device 820 includes the processor 410, the sensor module 420, the encoding and decoding unit 430, the vibrator 440, and the communication module 450, respectively, of FIG. 4.

In operation 830a, the first processor 811 of the first electronic device 810, upon detecting a connection request trigger, broadcasts beacon signals through a first medium (e.g., the communication module 815). After broadcasting the beacon signals through the first medium and when the connection transmission method included in the beacon signals is, e.g., a vibration signal generation method, the first processor 811 activates the motion sensor of the first sensor module 812 to wait to receive a vibration signal corresponding to the connection information.

The second processor 821 of the second electronic device 820 broadcasts beacon signals through the first medium (e.g., the second communication module 825). When the connection transmission method included in the beacon signal is a vibration signal generation method, the second processor 821 generates the connection information of a vibration signal related to the second medium (e.g., a desk) using the second vibrator 824.

In operation 830b, the second processor 821 transmits a vibration signal corresponding to the connection information to the first electronic device 810 through the second medium (e.g., a human body or desk) using the second vibrator 824. For example, when the second electronic device 820 is held in the user's hand, and the first electronic device 810 is a smartwatch put on the user's same arm, the second electronic device 820 transmits a vibration signal corresponding to the connection information to the first electronic device 810 via the human body, the second medium.

When receiving a vibration signal through the second medium (e.g., the human body or desk), the first processor 811 of the first electronic device 810 detects the connection information from the vibration signal detected through the motion sensor 812.

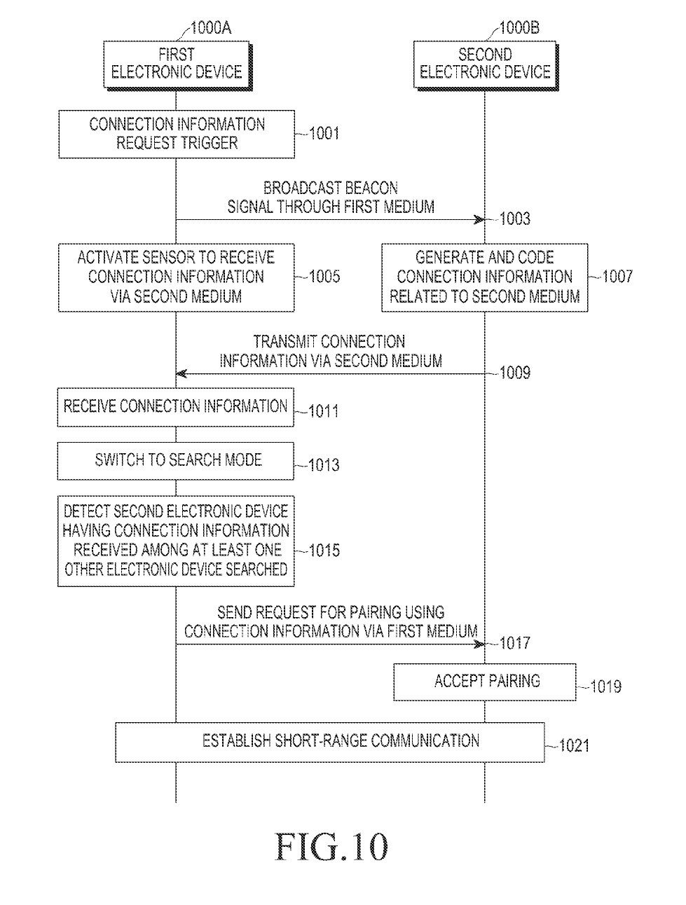

FIGS. 9A and 9B are block diagrams illustrating an operation of correcting a group by an electronic device according to an embodiment of the present disclosure. Referring to FIGS. 9A and 9B, the first electronic device 910 to the fourth electronic device 940 each includes the same components as those of the electronic device 401 of FIG. 4.

When communication is established among the first electronic device 910 to the fourth electronic device 940 so that a first group is completely formed, and the first electronic device 910 is designated as the host electronic device as shown in FIG. 9A, the first electronic device 910 periodically corrects the members of the group. The first electronic device 910 periodically checks if the second electronic device 920 to the fourth electronic device 940 are valid.

When checking the validity among the second electronic device 920 to the fourth electronic device 940, the second electronic device 920 is determined to be invalid as shown in FIG. 9B, the first electronic device 910 removes the second electronic device 920, completely forming a second group in which the first electronic device 910, the third electronic device 930, and the fourth electronic device 940 establish communication.

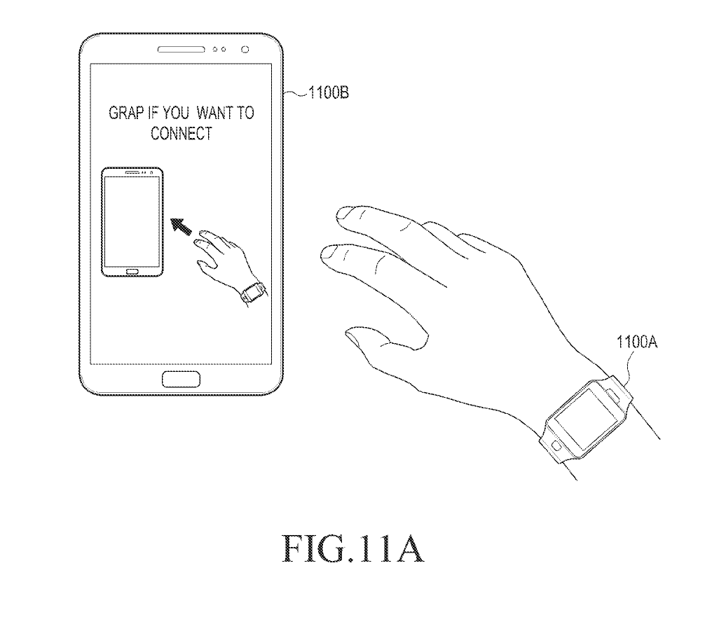

FIG. 10 is a call flow diagram illustrating a method for an electronic device to establish communication with another electronic device according to an embodiment of the present disclosure. Referring to FIG. 10, at least one of the first electronic device 1000A or the second electronic device 1000B includes at least one of the components of the electronic device 401 of FIG. 4.

Referring to FIG. 10, the first electronic device 1000A detects a connection information request trigger in operation 1001. In operation 1003, the first electronic device 1000A broadcasts connection information request signals, e.g., beacon signals, through a first medium (e.g., the communication module). In operation 1003, the second electronic device 1000B also broadcasts connection information request signals, e.g., beacon signals, through the first medium (e.g., the communication module). The electronic device state information included in the beacon signals respectively broadcasted from the first electronic device 1000A and the second electronic device 1000B includes a listening connection state value indicating a state of waiting to receive connection information.

An electronic device capable of generating connection information may be determined through the capability information (e.g., type or random priority value of the electronic device) included in the beacon signal via exchange of the beacon signals. The second electronic device 1000B may be determined as the electronic device for generating connection based on the capability information.

In operation 1005, the first electronic device 1000A activates the sensor corresponding to the connection information transmission method included in the beacon signal among the at least one sensor of the first electronic device 1000A to wait to receive connection information to be transmitted through the second medium.

In operation 1007, the second electronic device 1000B capable of generating connection information generates and encodes connection information related to the second medium. The connection information may be generated or extracted from at least one of a UI of the electronic device, a particular value already stored in the electronic device, a value generated automatically or randomly, a value recognized through sensor information (e.g., when the electronic device is put on the user's body, biometric information is recognized), a particular value received from a designated cloud server, a particular value transmitted from the other electronic device connected with the electronic device, a physical signal created in the electronic device (e.g., a motion signal created by the movement of the electronic device), or a physical signal applied from the outside (e.g., a signal generated when hitting the electronic device).

In operation 1009, the second electronic device 1000B sends the connection information to the first electronic device 1000A via the second medium (e.g., the human body or desk).

When the second electronic device 1000B generates and transmits the connection information to the first electronic device 1000A, the state information on the electronic device, which is included in the beacon signals broadcast at a predetermined cycle, includes a connection-ready state value indicating a state of waiting to receive connection information.

In operation 1011, the first electronic device 1000A, upon reception of the connection information via the second medium, extracts the connection information using the sensor activated to receive the connection information and decodes the encoded connection information. When the first electronic device 1000A receives the connection information, the state information on the electronic device, which is included in the beacon signals broadcast at a predetermined cycle, includes a connection-ready state value indicating a state of waiting to receive connection information.

In operation 1013, the first electronic device 1000A switches to a search mode when receiving the connection information. In operation 1015, the first electronic device 1000A searches for at least one other electronic device positioned near the first electronic device 1000A and detects the second electronic device 1000B including the received connection information among the at least one other electronic device searched. When the identity (ID) value and the connection key value in the connection information are distinct from each other, the first electronic device 1000A detects the second electronic device 1000B having the same identity (ID) value as the identity (ID) value of the connection information in operation 1015.

In operation 1017, the first electronic device 1000A sends a request for pairing to the second electronic device 1000B through the first medium (e.g., the communication module) using the connection key value of the connection information.

When the second electronic device 1000B accepts the pairing from the first electronic device 1000A in operation 1019, the first electronic device 1000A and the second electronic device 1000B establishes short-range communication automatically, in operation 1021. In operation 1021, the second electronic device 1000B automatically establishes communication with the first electronic device 1000A using connection method information (e.g., BLE, BT, or Wi-Fi) included in the beacon signal. Each of the first electronic device 1000A and the second electronic device 1000B in communication includes a connection-complete state value indicating to wait for connection in the electronic device state information included in the beacon signals broadcast in a predetermined cycle.

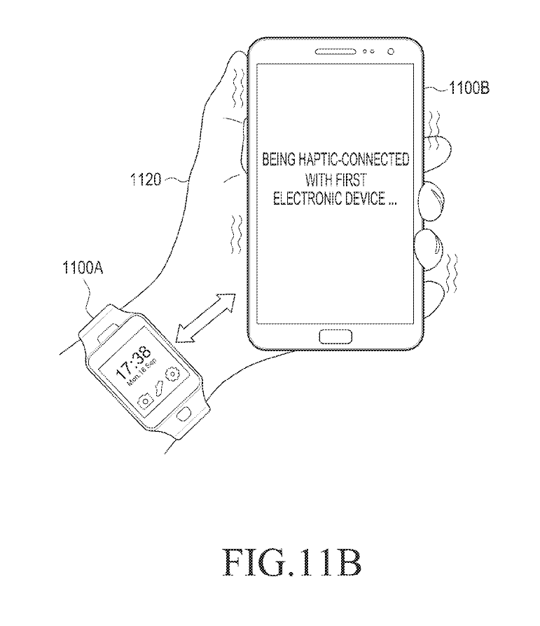

FIGS. 11A and 11B are views illustrating an operation of a method for an electronic device to establish communication with another electronic device according to an embodiment of the present disclosure.

Referring to FIGS. 11A and 11B, the first electronic device 1100A (e.g., a smartwatch) and the second electronic device 1100B (e.g., a smartphone) each includes at least one same component as the electronic device 401 of FIG. 4.

When the user wears the second electronic device 1100A on his arm while holding the first electronic device 1100B as shown in FIG. 11A, the display of the second electronic device 1100A displays a UI indicating that the first electronic device 1100B and the second electronic device 1100A may be connected with each other.

When the user wearing the second electronic device 1100A on his arm powers on the first electronic device 1100B while holding the second electronic device 1100A as shown in FIG. 11B, it may detect a connection request trigger so that beacon signals may be broadcast through the first medium (e.g., the communication module). The second electronic device 1100A generates a vibration signal corresponding to the connection information and transmits the vibration signal corresponding to the connection information to the first electronic device 1100B via the second medium 1120 of FIG. 11B (e.g., the human body). The display of the second electronic device 1100A displays a UI indicating that it is in a haptic-connection with the first electronic device 1100B.

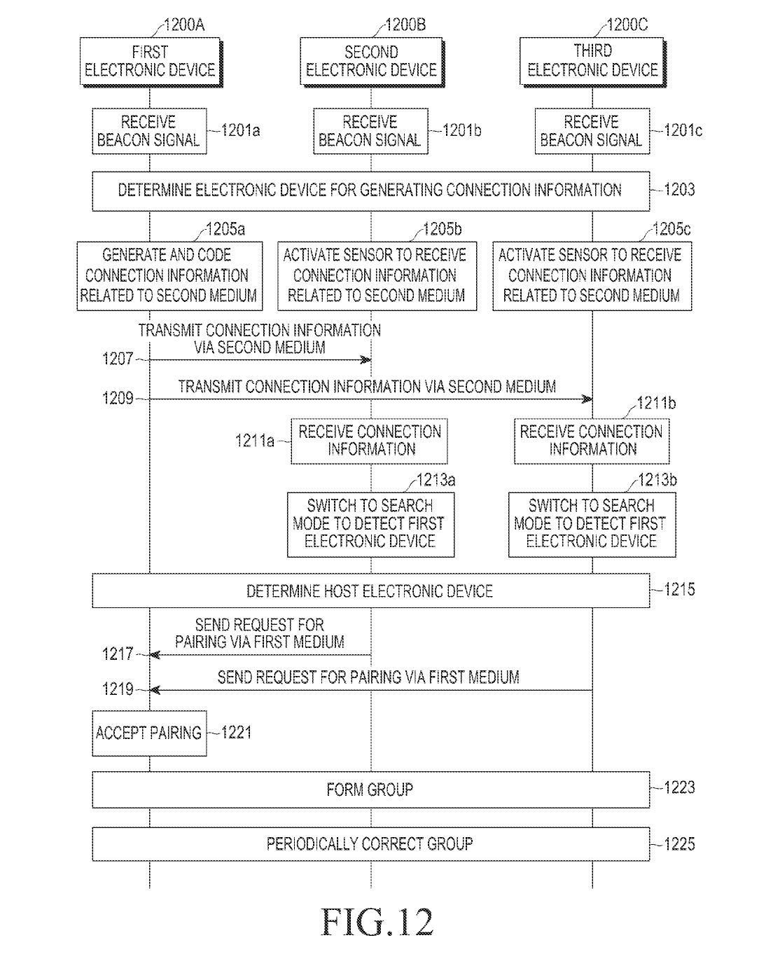

FIG. 12 is a call flow diagram illustrating a method for an electronic device to establish communication with a plurality of other electronic devices according to an embodiment of the present disclosure. Referring to FIG. 12, at least one of the first electronic device 1200A, the second electronic device 1200B, or the third electronic device 1200C includes at least one of the components of the electronic device 401 of FIG. 4.

In operations 1201A to 1201C, the first electronic device 1200A, the second electronic device 1200B, and the third electronic device 1200C each broadcasts beacon signals according to a connection information request trigger and receives the broadcast beacon signals. The electronic device state information contained in the beacon signals broadcasted from each of the first electronic device 1200A, the second electronic device 1200B, and the third electronic device 1200C contains a listening-connection state value indicating to wait for reception of connection information.

In operation 1203, each of the first electronic device 1200A, the second electronic device 1200B, and the third electronic device 1200C determines the electronic device capable of generating connection information through the capability information (e.g., type or random priority value of the electronic device) included in the broadcasted beacon signals. When the first electronic device 1200A is determined to be the electronic device for generating connection information based on the capability information, the first electronic device 1200A generates and encodes connection information related to the second medium in operation 1205a.

In operation 1205b, the second electronic device 1200B activates the sensor corresponding to the connection information transmission method included in the beacon signal among the at least one sensor of the second electronic device 1200B to wait to receive connection information to be transmitted through the second medium.

In operation 1205c, the third electronic device 1200C activates the sensor corresponding to the connection information transmission method included in the beacon signal among the at least one sensor of the third electronic device 1200C to wait to receive connection information to be transmitted through the second medium.

In operations 1207 to 1209, the first electronic device 1200A transmits the connection information to the second electronic device 1200B and the third electronic device 1200C via the second medium (e.g., the human body or desk). After transmitting the connection information to the second electronic device 1200B and the third electronic device 1200C, the first electronic device 1200A includes a connection-ready state value indicating to wait for connection in the electronic device state information included in the beacon signals broadcasted at predetermined cycles.

In operations 1211a and 1211b, each of the second electronic device 1200B and the third electronic device 1200C, upon reception of the connection information through the second medium from the first electronic device 1200A, extracts connection information using the sensor activated to receive the connection information and decodes the encoded connection information. After receiving the connection information from the first electronic device 1200A, each of the second electronic device 1200B and the third electronic device 1200C include a connection-ready state value indicating to wait for connection in the electronic device state information included in the beacon signals broadcasted at predetermined cycles.

In operations 1213a and 1213b, each of the second electronic device 1200B and the third electronic device 1200C switches to the search mode to search for at least one other electronic device nearby and detects the first electronic device 1200A including the received connection information (e.g., the identity value among the connection information items) among the at least one other electronic device searched.

In operation 1215, each of the first electronic device 1200A, the second electronic device 1200B, and the third electronic device 1200C exchanges and stores capability information through the beacon signal in the search mode and determine the host electronic device of the group by applying a predefined priority using the capability information (type or random priority of the electronic device). When the first electronic device 1200A is determined as the host electronic device based on the capability information, each of the second electronic device 1200B and the third electronic device 1200C send a request for pairing to the first electronic device 1200A using the connection information (e.g., the connection key value among the connection information items) via the first medium (e.g., the communication module) in operations 1217 to 1219.

When the first electronic device 1200A accepts the pairing with the second electronic device 1200B and the third electronic device 1200C in operation 1221, communication may be automatically established among the first electronic device 1200A, the second electronic device 1200B and the third electronic device 1200C in operation 1223, thereby forming one group. In operation 1223, communication may be automatically established among the first electronic device 1200A, the second electronic device 1200B, and the third electronic device 1200C using the connection method information (e.g., BLE, BT, or Wi-Fi) included in the beacon signal broadcast, forming a group. Each of the first electronic device 1200A, the second electronic device 1200B, and the third electronic device 1200C that are in communication with one another include a connection-complete value indicating to wait for connection in the electronic device state information included in the beacon signals broadcast in a predetermined cycle. In operation 1225, the first electronic device 1200A as the host electronic device, periodically performs grouping correction on the second electronic device 1200B and the third electronic device 1200C. In operation 1225, the first electronic device 1200A determines whether the second electronic device 1200B and the third electronic device 1200C are valid and removes the second electronic device 1200B or third electronic device 1200C, which is not determined to be valid, from the group. The determination of being valid may be based on at least one of an RSSI or round trip time (RTT) of the electronic device, a sensor measurement pattern, a connection history, a sensor information pattern stored in the host electronic device, or a sensor information pattern received from a cloud server.

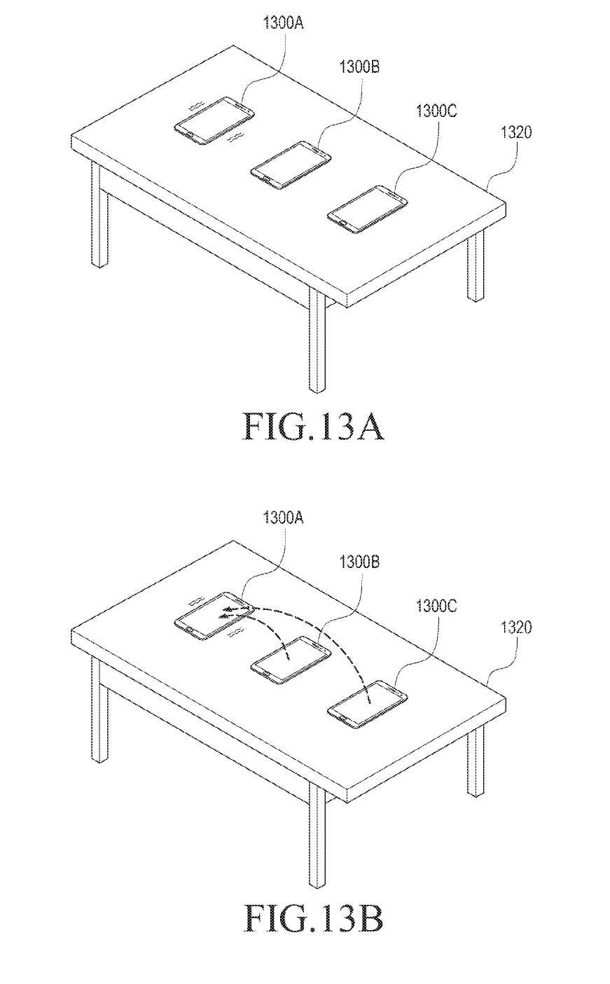

FIGS. 13A and 13B are diagrams illustrating an operation for an electronic device to establish communication with a plurality of other electronic devices according to an embodiment of the present disclosure.

Referring to FIGS. 13A and 13B, the first electronic device 1300A, the second electronic device 1300B, or the third electronic device 1300C each includes at least one same component as the electronic device 401 of FIG. 4.

When the first electronic device 1300A, the second electronic device 1300B, and the third electronic device 1300C are positioned on the desk 1320, and the first electronic device 1300A is designated as an electronic device to generate connection information based on the capability information in the beacon signals exchanged among the first electronic device 1300A, the second electronic device 1300B, and the third electronic device 1300C as shown in FIG. 13A, the first electronic device 1300A generates connection information, e.g., in a vibration signal, according to the connection information transmission method included in the beacon signal and encodes the same. Each of the second electronic device 1300B and the third electronic device 1300C activate the motion sensor according to the connection information transmission method included in the beacon signal and wait to receive the vibration signal corresponding to the connection information.

When the first electronic device 1300A transmits the vibration signal through the second medium, i.e., desk 1320, each of the second electronic device 1300B and the third electronic device 1300C, upon reception of the vibration signal through the motion sensor, decodes the received vibration signal. Each of the second electronic device 1300B and the third electronic device 1300C switches to the search mode to detect the first electronic device 1300A having the connection information. Each of the first electronic device 1300A, the second electronic device 1300B, and the third electronic device 1300C exchanges and stores capability information through the beacon signal in the search mode and determines which is the host electronic device of the group by applying a predefined priority using the capability information (type or random priority of the electronic device). The first electronic device 1300A may be determined as the host electronic device based on the capability information.

As shown in FIG. 13B, each of the second electronic device 1300B and the third electronic device 1300C send a request for pairing to the first electronic device 1300A, the host electronic device, using the connection information received through the first medium (e.g., the communication module). When the first electronic device 1300A accepts the pairing, the first electronic device 1300A, the second electronic device 1300B, and the third electronic device 1300C establish communication between the devices, forming a group.

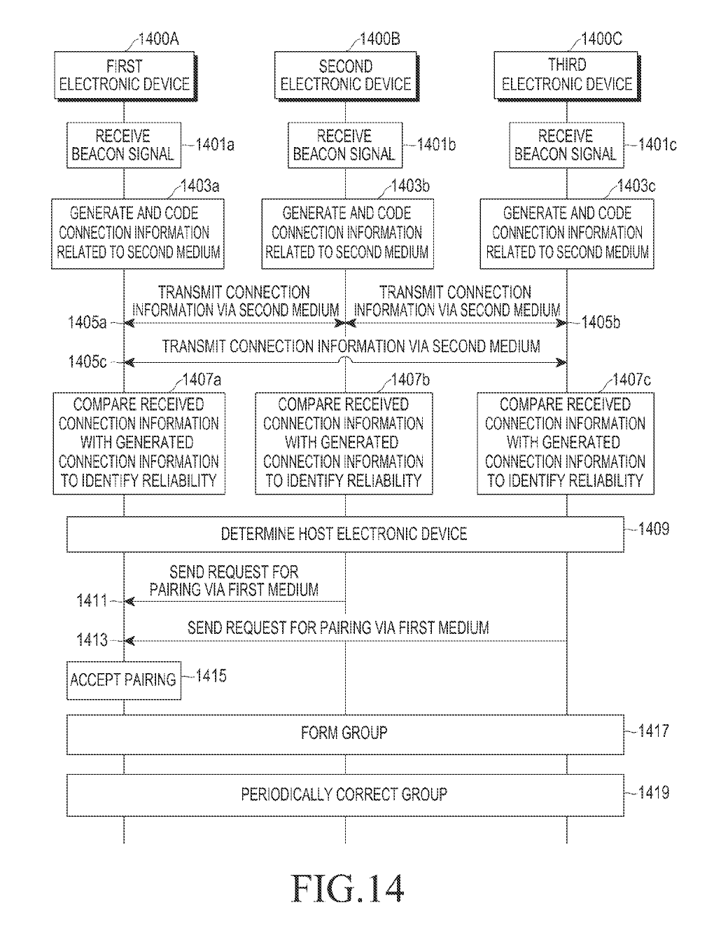

FIG. 14 is a flow diagram illustrating a method for an electronic device to establish communication with a plurality of other electronic devices according to an embodiment of the present disclosure. Referring to FIG. 14, at least one of the first electronic device 1400A, the second electronic device 1400B, or the third electronic device 1400C may include at least one of the components of the electronic device 401 of FIG. 4.

Referring to FIG. 14, the first electronic device 1400A, the second electronic device 1400B, and the third electronic device 1400C each broadcast beacon signals according to detection of a connection information request trigger and receive the broadcasted beacon signals in operations 1401a to 1401c. The electronic device state information contained in the beacon signals broadcast from each of the first electronic device 1400A, the second electronic device 1400B, and the third electronic device 1400C contain a listening-connection state value indicating to wait for reception of connection information.

In operations 1403a to 1403c, each of the first electronic device 1400A, the second electronic device 1400B, and the third electronic device 1400C generate and encode connection information related to the second medium (e.g., the human body or desk) based on the connection information transmission method included in the beacon signal. For example, each of the first electronic device 1400A, the second electronic device 1400B, and the third electronic device 1400C generate DNA signal information collected from the DNA sensor as the connection information and encodes the connection information on the human body where the first electronic device 1400A, the second electronic device 1400B, and the third electronic device 1400C all reside together.

In operations 1405a to 1405c, the first electronic device 1400A transmits the connection information generated from the first electronic device 1400A to the second electronic device 1400B and the third electronic device 1400C via the second medium, the second electronic device 1400B transmits the connection information generated from the second electronic device 1400B to the first electronic device 1400A and the third electronic device 1400C via the second medium, and the third electronic device 1400C transmits the connection information generated from the third electronic device 1400C to the first electronic device 1400A and the second electronic device 1400B via the second medium.

Each of the first electronic device 1400A, the second electronic device 1400B, and the third electronic device 1400C, after receiving the connection information, include a connection-ready state value indicating to wait for connection in the electronic device state information included in the beacon signals broadcast at predetermined cycles.

In operation 1407a, the first electronic device 1400A compares the connection information generated from the first electronic device 1400A with the connection information from the second electronic device 1400B and the connection information from the third electronic device 1400C which have been received via the second medium (e.g., the human body or desk).

In operation 1407b, the second electronic device 1400B compares the connection information generated from the second electronic device 1400B with the connection information from the first electronic device 1400A and the connection information from the third electronic device 1400C which have been received via the second medium.

In operation 1407c, the third electronic device 1400C compares the connection information generated from the third electronic device 1400C with the connection information from the first electronic device 1400A and the connection information from the second electronic device 1400B which have been received via the second medium.

When the result of the comparison shows consistency in the connection information or that the reliability in the difference between the two pieces of connection information meets a minimum threshold for each of the first electronic device 1400A, the second electronic device 1400B, and the third electronic device 1400C in operations 1407a to 1407c, any one of the first electronic device 1400A, the second electronic device 1400B, and the third electronic device 1400C may be determined as the host electronic device in operation 1409.

In operation 1409, each of the first electronic device 1400A, the second electronic device 1400B, and the third electronic device 1400C exchange and store capability information included in the beacon signals and determine the host electronic device of the group by applying a predefined priority using the capability information (type or random priority of the electronic device). When the first electronic device 1400A is determined as the host electronic device based on the capability information, each of the second electronic device 1400B and the third electronic device 1400C send a request for pairing to the first electronic device 1400A using the connection information via the first medium (e.g., the communication module) in operations 1411 to 1413.

When the first electronic device 1400A accepts the pairing with the second electronic device 1400B and the third electronic device 1400C in operation 1415, communication may be automatically established among the first electronic device 1400A, the second electronic device 1400B and the third electronic device 1400C in operation 1417, thereby forming one group. In operation 1417, communication may be automatically established among the first electronic device 1400A, the second electronic device 1400B, and the third electronic device 1200C using the connection method information (e.g., BLE, BT, or Wi-Fi) included in the beacon signal broadcast, forming a group. Each of the first electronic device 1400A, the second electronic device 1400B, and the third electronic device 1400C that are in communication with one another include a connection-complete value indicating to wait for connection in the electronic device state information included in the beacon signals broadcast in a predetermined cycle.

In operation 1419, the first electronic device 1400A, designated as the host electronic device, periodically performs grouping correction on the second electronic device 1400B and the third electronic device 1400C. In operation 1419, the first electronic device 1400A determines whether the second electronic device 1400B and the third electronic device 1400C are valid and may remove the second electronic device 1400B or third electronic device 1400C, which is not determined to be valid, out of the group. Determining the state of being valid may depend upon at least one of an RSSI or round trip time (RTT) measurement of the electronic device, a sensor measurement pattern, a connection history, a sensor information pattern stored in the host electronic device, or a sensor information pattern received from a cloud server.

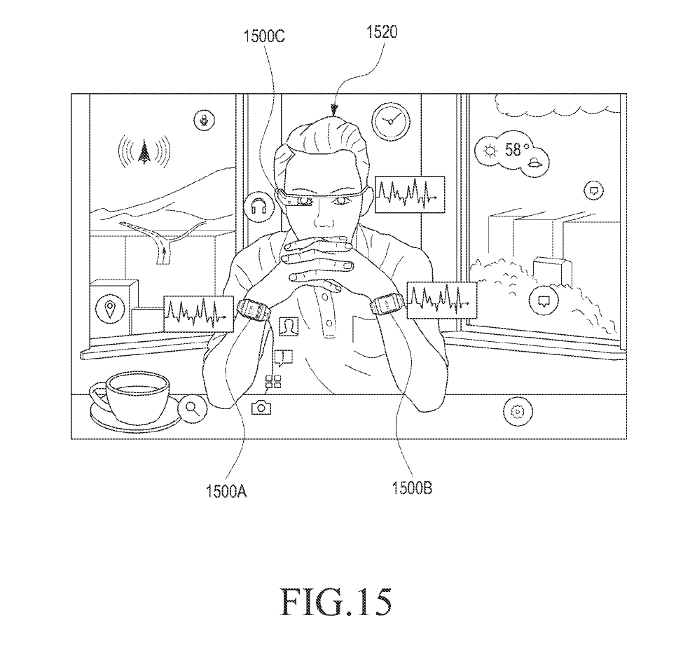

FIG. 15 is a diagram illustrating operation of an electronic device to establish communication with a plurality of other electronic devices according to an embodiment of the present disclosure.

Referring to FIG. 15, the first electronic device 1500A (e.g., a smartwatch), the second electronic device 1500B (e.g., a smartwatch), or the third electronic device 1500C (e.g., smart glasses) each includes at least one same component as the electronic device 401 of FIG. 4.

When the first electronic device 1500A and the second electronic device 1500B are worn on the right and left arms, respectively, of the user's body 1520, and the third electronic device 1500C is worn on the face of the user's body 1520, the second medium for the connection information transmission method included in the beacon signals exchanged among the first electronic device 1500A, the second electronic device 1500B, and the third electronic device 1500C may be the human body. Each of the first electronic device 1500A, the second electronic device 1500B, and the third electronic device 1500C generate connection information using DNA signal information collected through, (e.g., the DNA sensor), in order to transmit connection information through the human body 1520 that is the second medium.

Each of the first electronic device 1500A, the second electronic device 1500B, and the third electronic device 1500C compare the connection information generated with the connection information received, and when the result of the comparison shows consistency or that the difference between the two pieces of connection information exceeds a threshold, they may be determined to be electronic devices having the same connection information.

Each of the first electronic device 1500A, the second electronic device 1500B, and the third electronic device 1500C exchange and store capability information through the beacon signals and determine the host electronic device of the group by applying a predefined priority using the capability information (type or random priority of the electronic device). The first electronic device 1500A may be determined as the host electronic device based on the capability information.

Each of the second electronic device 1500B and the third electronic device 1500C send a request for pairing to the first electronic device 1500A, the host electronic device, using the connection information through the first medium (e.g., the communication module). When the first electronic device 1500A accepts the pairing, the first electronic device 1500A, the second electronic device 1500B, and the third electronic device 1500C establish communication between the electronic devices, forming a group.

According to an embodiment of the present disclosure, a method for establishing communication by an electronic device comprises receiving a signal from at least one or more other electronic devices via a first medium, analyzing the signal received from the at least one or more other electronic devices to generate data related to a second medium, and transmitting the generated data to the at least one or more other electronic devices having generated the signal.

According to an embodiment of the present disclosure, the data related to the second medium may be transmitted to the other electronic devices through the second medium, and the data related to the second medium may be generated based on the signal generated by the at least one or more other electronic devices.

According to an embodiment of the present disclosure, the second medium may be a material that the at least one or more other electronic devices and the electronic device may be placed on. The generated data related to the second medium may be transmitted to the at least one or more other electronic devices via the second medium. The at least one or more other electronic devices receive the data related to the second medium and transmit the signal via the first medium.

According to an embodiment of the present disclosure, the second medium may have the electronic device or the at least one or more other electronic devices placed thereon, and the data may be transmitted to the other electronic devices as a vibration signal through the second medium.

According to an embodiment of the present disclosure, the data related to the second medium includes information for connection of the electronic device via the first medium, and the at least one or more other electronic devices establishes communication with the electronic device via the first medium based on the data received from the electronic device.

According to an embodiment of the present disclosure, the data related to the second medium may be at least one of a user's biometric information that may be extracted from the second medium where the electronic device is placed. The method further comprises comparing the extracted biometric information with biometric information included in the data received from the at least one or more other electronic devices.

According to an embodiment of the present disclosure, the method further comprises comparing the biometric information included in the received data with the extracted biometric information, and when a matching degree between the electronic device and the at least one or more other electronic devices exceeds a predefined threshold, establishing communication via the first medium between the electronic device and the at least one or more other electronic devices. The matching degree may be generated by comparing one or more biometric information factors.

According to an embodiment of the present disclosure, the method further comprises transmitting the signal to the at least one or more other electronic devices via the first medium and receiving the data related to the second medium from the at least one or more other electronic devices via the second medium.

According to an embodiment of the present disclosure, the method further comprises activating at least one or more sensors to receive the data after transmitting the signal via the first medium.

According to an embodiment of the present disclosure, the method further comprises activating a motion sensor when the data is received as a vibration signal through the second medium.

As is apparent from the foregoing description, according to embodiments of the present disclosure, the electronic device and method for establishing communication by the same may establish communication in a simplified manner without any additional action by the user of the electronic device.

While the disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. An electronic device, comprising:
at least one communication module configured to receive a signal from at least one other electronic device through a first medium; and
a processor configured to analyze the signal received from the at least one other electronic device to generate data related to a second medium and to transmit the generated data to the at least one other electronic device having generated the signal.

2. The electronic device of claim 1, wherein the data related to the second medium is transmitted to the at least one other electronic device through the second medium, and wherein the data related to the second medium is generated based on the signal generated by the at least one other electronic device.

3. The electronic device of claim 2, wherein the second medium is a material that the at least one other electronic device and the electronic device is placed thereon, wherein the generated data related to the second medium is transmitted to the at least one other electronic device via the second medium, and wherein the at least one other electronic device receives the data related to the second medium and transmits the signal via the first medium.

4. The electronic device of claim 3, wherein the second medium has the electronic device or the at least one other electronic device placed thereon, and wherein the data is transmitted to the at least one other electronic device as a vibration signal through the second medium.

5. The electronic device of claim 2, wherein the data related to the second medium includes information for connection of the electronic device via the first medium, and wherein the at least one other electronic device establishes communication with the electronic device via the first medium based on the data received from the electronic device.

6. The electronic device of claim 1, wherein the data related to the second medium is at least one of a user's biometric information that may be extracted from the second medium where the electronic device is placed, and wherein the processor compares the extracted biometric information with biometric information included in the data received from the at least one other electronic device.

7. The electronic device of claim 6, wherein the processor is configured to compare the biometric information included in the received data with the extracted biometric information, and when a matching degree between the electronic device and the at least one other electronic device has exceeded a predefined threshold, is configured to establish communication via the first medium between the electronic device and the at least one other electronic device.

8. The electronic device of claim 1, wherein the processor is configured to transmit the signal to the at least one other electronic device via the first medium and is configured to receive the data related to the second medium from the at least one other electronic device via the second medium.

9. The electronic device of claim 8, wherein the processor is configured to activate at least one sensor to receive the data after transmitting the signal via the first medium.

10. The electronic device of claim 9, wherein the processor is configured to activate a motion sensor when the data is received as a vibration via the second medium.

11. A method for establishing communication by an electronic device, the method comprising:
receiving a signal from at least one other electronic device via a first medium;
analyzing the signal received from the at least one other electronic device to generate data related to a second medium; and
transmitting the generated data to the at least one other electronic device having generated the signal.

12. The method of claim 11, wherein the data related to the second medium is transmitted to the at least one other electronic device through the second medium, and wherein the data related to the second medium is generated based on the signal generated by the at least one other electronic device.

13. The method of claim 12, wherein the second medium is a material that the at least one other electronic device and the electronic device is placed thereon, wherein the generated data related to the second medium is transmitted to the at least one other electronic device via the second medium, and wherein the at least one other electronic device receives the data related to the second medium and transmits the signal via the first medium.

14. The method of claim 13, wherein the second medium has the electronic device or the at least one other electronic device placed thereon, and wherein the data is transmitted to the at least one other electronic device as a vibration through the second medium.

15. The method of claim 12, wherein the data related to the second medium includes information for connection of the electronic device via the first medium, and wherein the at least one other electronic device establishes communication with the electronic device via the first medium based on the data received from the electronic device.

16. The method of claim 11, wherein the data related to the second medium is at least one of a user's biometric information that may be extracted from the second medium where the electronic device is placed, and wherein the method further comprises comparing the extracted biometric information with biometric information included in the data received from the at least one other electronic device.

17. The method of claim 16, further comprising comparing the biometric information included in the received data with the extracted biometric information, and when a matching degree between the electronic device and the at least one other electronic device has exceeded a predefined threshold, establishing communication via the first medium between the electronic device and the at least one other electronic device.

18. The method of claim 11, further comprising:
transmitting the signal to the at least one other electronic device via the first medium; and
receiving the data related to the second medium from the at least one other electronic device via the second medium.

19. The method of claim 18, further comprising activating at least one sensor to receive the data after transmitting the signal via the first medium.

20. The method of claim 19, further comprising activating a motion sensor when the data is received as a vibration through the second medium.
